(19) United States
(12) Patent Application Publication
(10) Pub. No.: US 2008/0170544 A1
(43) Pub. Date: Jul. 17, 2008

(54) METHOD OF TRANSMITTING BETWEEN TWO NODES

(75) Inventors: Kevin Tang, Dublin, CA (US); Cedric Westphal, San Francisco, CA (US); Ying Ye, Mountain View, CA (US); Meghana Sahasrabudhe, Sunnyvale, CA (US); Naheed Vora, Santa Clara, CA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/775,813

(22) Filed: Jul. 10, 2007

(30) Foreign Application Priority Data
Jan. 15, 2007 (IB) PCT/IB07/00105

(51) Int. Cl. H04Q 7/00; H04L 12/28

(52) U.S. Cl. 370/329; 370/343; 370/400; 455/452.1

(57) ABSTRACT

A method comprising transmitting a busy signal from a first node; receiving said busy signal at a second node; and transmitting data from said second node to said first node on a channel associated with said busy signal.

### FIELD OF THE INVENTION

The present invention relates to a method of transmitting between two nodes and in particular but not exclusively to two nodes in a mesh or ad hoc network.

### BACKGROUND OF THE INVENTION

A diverse range of communication systems are in use today enabling communication between two or more entities, such as user equipment and/or other nodes associated with the system.

Wireless networks with wireless routers as network nodes on a mesh network basis have been proposed. The key components of such a wireless routing network are routed mesh network architecture, wireless routers, a wireless operating system and the deployment and management of the network. Wireless ad-hoc and mesh networks have gained an enormous amount of research, standardization and development activities in recently years due to their cost-efficiency and easy deployment with reduced dependence on existing infrastructure in many applications including networking for personal area, home, enterprise and community communications, backhaul for metro scale WiFi access networks, military and emergency operations.

Routed mesh networks mirror the structure of a wired network, such as for example the Internet. Each radio transceiver at a node in the wireless network becomes part of the infrastructure and can route data through the wireless mesh network to its destination just as in the wired Internet. The advantage of such a routed mesh networks is that line-of-sight problems can be reduced in comparison to a client/base station architecture because each node only needs line-of-sight to one other node in the network and not all the way to the ultimate destination of the data traffic, e.g. the point-of-presence (POP). With such an infrastructure the reach and coverage of the wireless network is extended with a minimal amount of wireless network infrastructure and interconnection costs. The data traffic can be routed around obstructions rather than needing to deploy additional base stations for line-of-sight in densely populated diverse geographical locations. The more wireless routers are added to the network, the more robust and far-reaching the network becomes.

In the above mentioned wireless routing network, wireless routers with omni-directional antennas are used as a network node. Each wireless router can communicate with other nodes, i.e. other wireless routers in any direction. The omni-directional antennas offer a 360-degree range and do not require precise pointing or steering. Therefore additional wireless routers can be added in an ad hoc and incremental fashion.

Wireless mesh networks based on a multipoint-to-multipoint architecture make an ad hoc integration of new nodes, i.e. wireless routers, easier since the actual demand and traffic flow in such a wireless network environment makes it much easier to adjust the coverage and bandwidth needs than designing network ahead of time. Adaptive routed mesh network make obstructions to the line-of-sight by growing trees or temporary obstructions less problematic, since the data traffic is automatically re-routed through as a link becomes unavailable. The nodes, i.e. wireless routers, in such a wireless routing network environment can adapt to changes in the link availability and the quality in real-time.

Using multiple radio frequency channels in wireless ad-hoc or mesh networks can dramatically increase the throughput and delay performance due to the fact that multiple transmissions can take place simultaneously on different channels without interfering with one another. As such, an efficient and correct channel allocation scheme is required for a multi-channel MAC medium access control protocol in wireless ad-hoc or mesh networks.

In such a wireless ad-hoc or mesh network, the nodes and radio links form a multi-hop mesh topology due to the radio propagation characteristics. One problem is to find a distributed way to allocate a fixed number of available frequency channels dynamically to the transmissions such that collisions of data packets are avoided at receivers.

In the IEEE 802.11 s draft, the RTX/CTX (ready to switch/clear to switch) handshake is used on a common control channel for the receiver and transmitter to agree on the channel to be used for data.

The Distributed Scheduling in 802.16-2004 mesh mode adopts the Request/Grant/Grant handshake in the Schedule Control Sub-frames or the free portions of Data Sub-frames for the receiver and transmitter to agree on the channel for data transmission. The centralized scheduling is not considered here since normally ad-hoc/mesh networks lack any central base stations.

In S.-L. Wu, C.-Y. Lin, Y.-C. Tseng, and J.-P. Sheu, “A new multi-channel MAC protocol with on-demand channel assignment for mobile ad hoc networks,” Proc. ISPAN 2000. and J. So and N. Vaidya, “Multi-channel MAC for ad hoc networks: handling multi-channel hidden terminals using a single transceiver,” Proc. ACM MobiHoc 2004 reliance is placed on using either the 802.11 ATIM window (in time) or a common channel to do RTS/CTS (ready to send/clear to send) or similar exchanges to negotiate data channels between nodes.

However, the above described arrangements have the problem that none of the above schemes guarantees that the interfering transmissions will not be allocated the same channel. One main reason for this is that these schemes lack a mechanism for each node to promptly collect the complete and correct information about the channel usage in its neighbourhood. Allocations in these schemes are typically based on channel information from overheard packets such as RTS, CTS and ATIM-ACK (announcement traffic indication message—acknowledgement) packets or from carrier sensing, which can be incorrect. These schemes also lack a method for nodes to quickly detect possible collisions. Therefore, nodes cannot recover from the transmission error until the transmission is finished.

Busy tone has been used by MAC (medium access controls) protocols to combat the hidden terminal and exposed terminal problems in multi-hop radio networks. In this regard, reference is made to F. Tobagi and I. Kleinrock, “Packet switching in radio channels: part II—the hidden terminal problem in carrier-sense multiple access and the busy -tone solution,” IEEE trans. On Communications, vol 23, no. 12, pp 1417-1433, December 1975, C.-S. Wu and V. O. K. Li, “Receiver-initiated busy-tone multiple access in packet radio networks,” Proc. SIGCOMM, pp. 336-342, 1988, and A. C. V. Gummalla and J. O. Limb, “Design of an access mechanism for a high speed distributed wireless LAN,” IEEE Journal on Selected Areas in Communications, vol. 18, no. 9 pp. 1740-1750, September 2000.

It is an aim of at least some of the embodiments of the invention to address or at least mitigate one or more of these problems.

### SUMMARY OF THE INVENTION

According to a first aspect there is provided, a method comprising: transmitting a busy signal from a first node; receiving said busy signal at a second node; and transmitting data from said second node to said first node on a channel associated with said busy signal.

According to another aspect, there is provided a system comprising: a first node configured to transmit a busy signal; a second node configured to receive said busy signal and to transmit data from said second node to said first node on a channel associated with said busy signal.

According to another aspect, there is provided a node comprising: a first radio for receiving and/or transmitting busy tones; a second radio for receiving and/or transmitting traffic, said first and second radios being arranged to operate at the same time.

According to another aspect, there is provided a second node comprising: a receiver operable to receive a busy signal from a first node; a processor operable to determine a channel for transmitting data to said first node in dependence on said busy signal; a transmitter operable to transmit data on said determined channel to said first node.

According to another aspect, there is provided a second node comprising: means for receiving a busy signal from a first node; and means for determining a channel for transmitting data to said first node in dependence on said busy signal; means for transmitting data on said determined channel to said first node.

According to another aspect, there is provided a first node comprising: means for receiving information identifying available channels from a second node; means for determining an available channel using said information; and means for transmitting a busy tone in dependence on the determined available channel to said second node.

According to another aspect, there is provided a first node comprising: a receiver configured to receive information identifying available channels from a second node; a processor operable to determine an available channel using said information; and a transmitter configured to transmit a busy tone in dependence on the determined available channel to said second node.

### BRIEF DESCRIPTION OF DRAWINGS

For a better understanding of the present invention and as to how the same may be carried into effect, reference will now be made by way of example only to the accompanying drawings in which:

FIG. 1 shows a routing network with which embodiments of the present invention can be used;

FIG. 2 shows a timing diagram illustrating a dynamic channel allocation with busy tones in accordance with an embodiment of the invention;

FIG. 3 shows a schematic diagram of a network node embodying the present invention.

### DETAILED DESCRIPTION OF EMBODIMENTS OF THE INVENTION

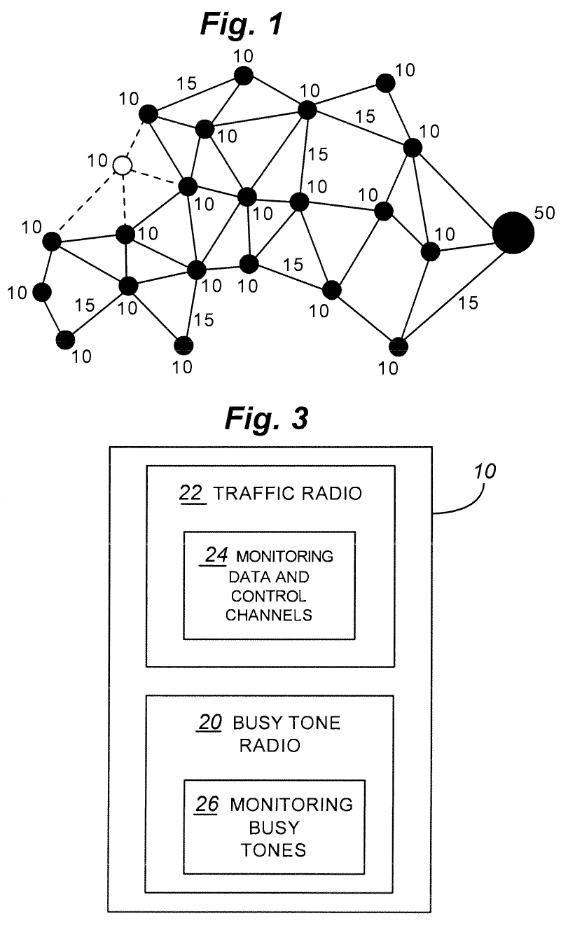

Embodiments of the present invention are particularly applicable to wireless communication networks or systems. In particular, embodiments of the invention are applicable to wireless mesh networks or ad-hoc network. FIG. 1 shows a schematic representation of the wireless network with a plurality of network nodes 10. Each network node 10 is connected to neighbouring network nodes 10 via a multipoint-to-multipoint line-of-sight connection 15 by which the network nodes 10 communicate with each other. The wireless network comprise a Point-of-Presence POP 50 by which the wireless network is connected to the Internet or any other network.

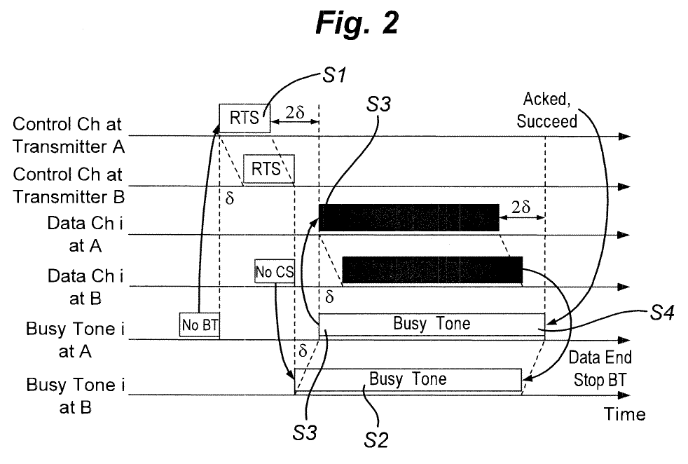

Reference is made to FIG. 2 which shows a timing diagram for an embodiment of the invention and FIG. 3 which schematically shows a node embodying the present invention.

In an embodiment of the invention, a busy tone is used. In particular, one busy tone (signal) is applied for each data channel. Assertion of a busy tone is used during the channel allocation time as the indication of an agreement on selecting the corresponding channel.

In another embodiment of the invention, the above scheme is combined with the approach where a request packet containing channel selection information by the sender is communicated to the receiver using a common channel Embodiments of the invention may use one or several OFDM sub-carriers as a busy tone and use the same type of radios as those for data.

A schematic view of a node 10 embodying the present invention is shown. In some embodiments of the invention, each node is equipped with two independent radios, one for the busy tones,—a busy tone radio 20, and one for the data and control packets,—a traffic radio 22. In alternative embodiments, one radio which can independently handle busy tones and data/control packets can be used. Each radio may be half-duplex, i.e., it can either receive or transmit but cannot transmit and receive simultaneously. In alternative embodiments, each radio may be full duplex, that is able to transmit and receive at the same time.

There are N busy tones available for the busy tone radio, and bandwidth of the traffic radio is divided into N data channels and one control channel. However in alternative embodiments of the invention, the number of busy tones and data channels maybe different.

Each data channel is assigned with a busy tone. The traffic radio can receive on all channels at the same time while the busy tone radio can receive all busy tones simultaneously.

A busy tone is a narrowband signal and thus the bandwidth used for busy tone radio can be substantially smaller compared with that of the traffic radio. Therefore the bandwidth overhead can be limited. The busy tone radio can be implemented using OFDM (Orthogonal Frequency Division Multiplexing) technology with one or several sub-carriers to be used for each busy tone.

A busy tone can be a sine waveform. As such, the bandwidth for a busy tone may depend on how narrow the filter can be implemented. OFDM or OFDMA technology makes use of very narrow filters. For example, in the IEEE 802.11a standard, each data channel is about 20 MHz and typically can have about 80 subcarriers with each subcarrier having 250 kHz bandwidth. In some embodiments, not all the subcarriers are used for data since some of them need to be used as guard carriers or pilot carriers etc.

If a sine waveform is used as a busy tone with 250 kHz filters, then the overhead for one busy tone would be about 1.25% of a data channel.

If one subcarrier is used for each busy tone, the overhead is the same, which is 1/80=1.25%. If five subcarriers are used instead, then the overhead would be 6.25%.

In the IEEE 802.11a standard, there are total twelve data channels. One design could use one data channel as the signaling channel and ten data channels as the data channels and the remaining one (which has 20 MHz) for busy tones, which can provide more than 10 busy tones if five subcarriers are used for each busy tone.

For any given node, a free channel for transmitting is one or more of those channels whose busy tone is not detected; likewise, free channels for receiving are those channels on which no carrier is sensed. When a node is not transmitting with the traffic radio, the node monitors all data channels and the control channel and thus knows all the free channels for receiving. This may be done by a monitoring data and control channels functionality 24 of the traffic radio 22. In alternative embodiments, where a full-duplex traffic radio is used, the node can monitor all the channels on which it is not currently transmitting. Likewise, when a node is not transmitting with the busy tone radio, it monitors all the busy tones and thus knows all the free channels for transmitting. In alternative embodiments, where a full-duplex busy tone radio is used, the node can monitor all the busy tones except the one it is transmitting, if any. This may be done by a busy tone monitoring functionality 26 of the busy tone radio 20.

The dynamic channel allocation protocol embodying the present invention is shown in FIG. 2.

When a node A has data for a neighbour B, it sends an RTS (Ready to Send) packet to B on the control channel. This is done by step S1. The RTS contains a set of free channels for transmitting seen by A.

In step S2, node B receives the RTS successfully, node B comes up with a set of free channels for this transmission, which are the channels that are both in the free transmitting channel set from the RTS and the local free receiving channel set at B. If the set is not empty, the receiver picks one data channel either randomly or according to an algorithm and transmits the corresponding busy tone with the busy tone radio. Node B does not need to send any control packet back to the sender because this is one of the purposes of the busy tone. The busy tone performs this functionality.

In step S3, if node A detects that a busy tone corresponding to one of the data channels listed in the RTS packet is asserted within a time 2 δ after the RTS is sent, where δ is the sum of the processing delay and the propagation time between node A and its neighbour node B, the allocation is considered to be successful and node A starts to send data on the corresponding data channel for which it receives the busy tone. If no busy tone corresponding to any of the data channels listed in the RTS packet is detected, the attempt is considered to be a failure and node A will try again after a random backoff time.

Node B stops transmitting the busy tone if it does not receive data within a predetermined time or detects an unrecoverable error in the data or finishes receiving data. The predetermined time may be greater than or equal to 2 δ. If node A stops receiving the busy tone for its transmission, it stops transmitting data and will try again later after a random delay by sending another RTS with the same procedure.

If after all packets are sent and the busy tone is still presented (for a 2δ period of time) then the transmission is considered to be successful by node A as shown by step S4.

In addition to serving as an acknowledgment to the data packets and a busy jamming signal to the potential interfering transmitters, the busy tone may also serve as the final channel selection indication.

If the duration of the RTS packet is greater than 2 δ, then only one of node A's neighbours, which is B, can both receive an RTS correctly and transmit a busy tone which can be detected by node A within a 2 δ period after the RTS is sent. At that point, all neighbours of node B can detect the busy tone sent by B, which indicates that the data channel is not free for transmitting. In some embodiments, the duration time of the RTS packet can be greater than 2 δ, for example 3 δ.

Embodiments of the invention may address the distributed channel allocation problem in multi-channel ad-hoc or mesh networks. The protocol is simple and is on-demand.

Each node may be equipped with two independent radios and may be able to receive on all the channels simultaneously.

Embodiments of the invention may be applied in a number of different scenarios. By way of example:
Wireless ad-hoc and mesh network development, which is an active ongoing topic of IEEE 802 standardizations.
Embodiments of the invention may solve the distributed channel allocation problem in a simple, correct and on-demand way. Therefore it can benefit any ad-hoc/mesh networks.

It should be noted that aspects of the method can be implemented at least partially in software and accordingly embodiments of the present invention comprise a computer program arranged to implement at least some of the steps of the method described in relation to FIG. 2.

Preferred embodiments of the present invention use a busy tone. However, in alternative embodiments of the invention, other forms of a busy signal may be used.

Preferred embodiments of the invention have mentioned transmitting the busy tone on sub-carriers using OFDM techniques. It should be appreciated that the busy tones can be transmitted on respective channels. Any other suitable technique may be used to transmit the one or more busy tones.

1. A method comprising
transmitting a busy signal from a first node;
receiving said busy signal at a second node; and
transmitting data from said second node to said first node on a channel associated with said busy signal.

2. A method as claimed in claim 1, comprising transmitting data on one of a plurality of data channels.

3. A method as claimed in claim 2, wherein each of said data channels has associated therewith a respective busy signal.

4. A method as claimed in claim 3, comprising transmitting data from said second node to said first node on the data channel associated with said busy signal.

5. A method as claimed in claim 3, wherein each busy signal is associated with a different channel.

6. A method as claimed in claim 3, wherein each busy signal is associated with a different subcarrier.

7. A method as claimed in claim 6, wherein said busy signal is an Orthogonal Frequency Division Multiplexing signal.

8. A method as claimed in claim 1, wherein said busy signal comprises a busy tone.

9. A method as claimed in claim 1, wherein said busy signal has a bandwidth which is smaller than that of said channel.

10. A method as claimed in claim 1, comprising determining on which one or more channels said second node is able to transmit to the first node.

11. A method as claimed in claim 10, wherein said determining on which one or more channels said second node is able to transmit to said first node comprises those channels for which a busy signal is not received.

12. A method as claimed in claim 10, comprising transmitting from the second node to the first node information identifying one or more channels on which the second node is able to transmit to the first.

13. A method as claimed in claim 1, comprising determining on which one or more channels said first node is able to receive from the second node.

14. A method as claimed in claim 13, wherein said determining on which one or more channels said first node is able to receive from said second node comprises those channels on which no carrier is detected.

15. A method as claimed in claim 1, comprising selecting a channel in the first node, said channel being one on which said first node is able to receive from said second node and said second node is able to transmit to the first node.

16. A method as claimed in claim 1, wherein second node is arranged to transmit data if a busy signal is received from the first node within a period which is twice sum of a processing delay and a maximum propagation time between said first and second nodes.

17. A method as claimed in claim 1, comprising stopping transmitting said busy signal in response to at least one of: data not being received from said second node; an error in received data; or transmission of data from said second node is completed.

18. A system comprising
a first node configured to transmit a busy signal;
a second node configured to receive said busy signal and to transmit data from said second node to said first node on a channel associated with said busy signal.

19. A node comprising:
a first radio for receiving and/or transmitting busy tones;
a second radio for receiving and/or transmitting traffic, said first and second radios being arranged to operate at the same time.

20. A node as claimed in claim 19, wherein at least one of said first and second radios comprises one of a half duplex radio and a full duplex radio.

21. A second node comprising:
a receiver operable to receive a busy signal from a first node; and
a processor operable to determine a channel for transmitting data to said first node in dependence on said busy signal;
a transmitter operable to transmit data on said determined channel to said first node.

22. A second node comprising:
means for receiving a busy signal from a first node; and
means for determining a channel for transmitting data to said first node in dependence on said busy signal;
means for transmitting data on said determined channel to said first node.

23. A first node comprising:
means for receiving information identifying available channels from a second node;
means for determining an available channel using said information; and
means for transmitting a busy tone in dependence on the determined available channel to said second node.

24. A first node as claimed in claim 23, comprising means for receiving data on the determined available channel from said second node

25. A first node comprising:
a receiver configured to receive information identifying available channels from a second node;
a processor operable to determine an available channel using said information; and
a transmitter configured to transmit a busy tone in dependence on the determined available channel to said second node.

26. A first node as claimed in claim 25, comprising a receiver configured to receive data on the determined available channels from said second node.
